(19) United States
(12) Patent Application Publication
(10) Pub. No.: US 2025/0244105 A1
(43) Pub. Date: Jul. 31, 2025

(54) SYSTEM AND METHOD FOR GENERALIZING IDENTIFIED AND UNIDENTIFIED TARGET DATA IN FIXED ANTI-AIRCRAFT WEAPON SYSTEM

(71) Applicant: HANWHA AEROSPACE CO., LTD., Changwon-si (KR)

(72) Inventors: Jin Yong HWANG, Changwon-si (KR); Young Woon Kim, Changwon-si (KR); Dong Hwi Han, Changwon-si (KR); Sang Hun Yang, Changwon-si (KR)

(73) Assignee: HANWHA AEROSPACE CO., LTD., Changwon-si (KR)

(21) Appl. No.: 19/036,977

(22) Filed: Jan. 24, 2025

(30) Foreign Application Priority Data
Jan. 26, 2024 (KR) 10-2024-0012202

(51) Int. Cl. F41G 3/14; F41H 11/02

(52) U.S. Cl. CPC F41G 3/14; F41H 11/02

(57) ABSTRACT

A system may include: a fixed weapon system configured to detect and identify targets; a central control system configured to control the fixed weapon system, identify the targets detected by the fixed weapon system based on preset learning information, classify the targets according to preset data; an unidentified information search system configured to search for information about an unidentified target among the targets, that is not identified, based on the preset learning information; a storage configured to receive and store the information about the unidentified target from the unidentified information search system; and a learning device configured to receive the information about the unidentified target that is stored in the storage, determine whether the information about the unidentified target is within a learnable range for performing learning for identifying the unidentified target, and perform the learning based on the information.

### CROSS-REFERENCE TO RELATED APPLICATION

This application claims priority from Korean Patent Application No. 10-2024-0012202, filed on Jan. 26, 2024 in the Korean Intellectual Property Office, and all the benefits accruing therefrom under 35 U.S.C. 119, the disclosure of which in its entirety is herein incorporated by reference.

### BACKGROUND

### 1. Field

Embodiments of the present disclosure relate to a system and method for generalizing identified and unidentified target data in a fixed anti-aircraft weapon system, and more particularly, to a system and method for generalizing identified and unidentified target data in a fixed anti-aircraft weapon system, which not only identify targets through image-based detection/identification sensors mounted on the fixed anti-aircraft weapon system, but also searches, learns, and generalizes information on unidentified targets to maximize mission efficiency, scalability, and capabilities.

### 2. Description of Background Art

Artificial intelligence (AI)-based technologies such as deep learning use supervised learning methods, which perform identification, recognition, and classification by training on data with predefined answers.

In the case of these supervised learning methods, detailed analysis can be performed on identification information trained by operators using pre-stored databases. However, it is either impossible or highly difficult to analyze unconfirmed information outside of the trained information, and the analyzed information is inevitably restricted.

Particularly, the target data of enemy nations related to national defense are limited in collection and acquisition, and the likelihood of errors is high since analysis is performed visually by operators, which inherently reduces mission efficiency. Therefore, it is necessary to continuously update the database for identifying enemy targets in national defense and continuously collect and analyze information on enemy equipment, etc.

Specifically, generalization is limited during the operation of weapon systems. For example, when training a learning model using a supervised learning method of the background art for identifying enemy targets in national defense, the learning model and its operational environment data inevitably differ from the real operational environment data. Consequently, training must be performed using different data from the real operational environment, limiting generalization in actual operations.

Furthermore, detailed analysis of unidentified targets is limited. For example, technologies of the background art can only perform detailed information analysis through a database for pre-trained targets, and there are limitations in detecting and identifying untrained targets outside of the database information.

Additionally, maintaining mission continuity through continuous monitoring is difficult. For example, in technologies of the background art, for unconfirmed targets beyond pre-trained target data during mission execution, operators must perform friend-or-foe identification, threat analysis, and reporting to higher systems through continuous monitoring, limiting their ability to leave their post or perform other tasks simultaneously.

Also, mission efficiency is reduced. For example, in technologies of the background art, operators must directly perform friend-or-foe identification and threat analysis for unconfirmed targets outside of pre-trained target data, continuously checking various information without distinguishing between friend and foe during missions. Without further updates on unconfirmed targets, detailed analysis is impossible, reducing mission efficiency.

Thus, in a fixed anti-aircraft weapon system, air targets are detected through detection/identification sensors (e.g., radar and imaging components), information on the detected targets is continuously collected, and the collected information is displayed on a central control system, which performs threat analysis/classification procedures for all displayed targets.

### SUMMARY

In view of the above, a system and method for generalizing identified and unidentified target data in a fixed anti-aircraft weapon system are needed for finding the most matching information for unidentified targets outside of pre-trained target data from an unidentified information search engine, storing the found information in a learning server for retraining, updating the central control system, and communicating the re-trained and updated unidentified target data to surrounding allies and higher systems through networks.

According to some embodiments of the present disclosure, a system may be provided and include: a fixed weapon system including at least one weapon device fixed at a predetermined position, the fixed weapon system configured to detect and identify targets; a central control system configured to control the fixed weapon system, identify the targets detected by the fixed weapon system based on preset learning information, classify the targets according to preset data; an unidentified information search system configured to search for information about an unidentified target among the targets, that is not identified, based on the preset learning information; a storage configured to receive and store the information about the unidentified target from the unidentified information search system; and a learning device configured to receive the information about the unidentified target that is stored in the storage, determine whether the information about the unidentified target is within a learnable range for performing learning for identifying the unidentified target, and perform the learning based on the information.

According to an embodiment of the present disclosure, the central control system is further configured to display the targets that are detected to an operator, classify the targets according to a threat classification criteria, and identify the targets that are classified as threats, starting from a target with a highest threat priority, using the preset learning information.

According to an embodiment of the present disclosure, the threat classification criteria includes at least one from among an armed status of the targets, an appearance frequency of the targets, an expected movement path of the targets, a distance of the targets, and a speed of the targets.

According to an embodiment of the present disclosure, the central control system further includes a display, and the central control system is configured to cause the display to display all targets detected by the fixed weapon system.

According to an embodiment of the present disclosure, the central control system is further configured to cause the display to display the unidentified target that cannot be identified by the central control system according to the preset learning information, and wherein the system further includes an outputter, and the central control system is further configured to cause the outputter to alert the operator to detection of the unidentified target.

According to an embodiment of the present disclosure, the learning device is further configured to: determine whether a result of the learning performed by the learning device, based on the information about the unidentified target, has exceeded a predetermined threshold value; and update learned information and transmit result of the learning to the central control system based on the result exceeding the predetermined threshold value.

According to an embodiment of the present disclosure, the central control system is further configured to update identification information about the unidentified target based on the result of the learning.

According to an embodiment of the present disclosure, the central control system is further configured to distribute the identification information that is updated to the fixed weapon system, a designated ally, or another system configured to command the fixed weapon system or the designated ally.

According to an embodiment of the present disclosure, the unidentified information search system is further configured to search for at least one piece of the information corresponding to the unidentified target by: using one from among a first search engine of at least one internal database, a second search engine of at least one external network, and a third search engine of at least one operator-designated search engine; or interlinking at least two from among the first search engine, the second search engine, and the third search engine based on an input of a user.

According to an embodiment of the present disclosure, the unidentified information search system is further configured to: perform a first search for the at least one piece of the information corresponding to the unidentified targets by searching using the one from among the first search engine, the second search engine, and the third search engine; and based on the first search not being sufficient to identify the unidentified target, perform a second search for the at least one piece of the information corresponding to the unidentified target using another from among the first search engine, the second search engine, and the third search engine.

According to an embodiment of the present disclosure, the storage is further configured to store augmented target data or synthesized target data when storing the information about the unidentified target, and wherein the learning device is further configured to perform the learning using the information about the unidentified target and at least one from among the augmented target data and the synthesized target data.

According to embodiments of the present disclosure, a method performed by at least one processor may be provided and include: detecting targets by at least one fixed weapon device of a fixed weapon system; receiving information about the targets from the fixed weapon system; attempting to identify the targets based on preset learning information; displaying the targets on a display; classifying the targets according to preset data; determining that there is an unidentified target among the targets that are attempted to be identified; searching, based on determining that there is the unidentified target among the targets, for information about the unidentified target; determining whether the information about the unidentified target is within a learnable range for performing learning for identifying the unidentified target; obtaining learned information about the unidentified target by performing, based on determining that the information about the unidentified target is within the learnable range, the learning based on the information about the unidentified target; updating identification information about the unidentified target based on the learned information about the unidentified target; and transmitting the identification information, that is updated, to the fixed weapon system.

According to an embodiment of the present disclosure, the classifying the targets includes obtaining threat priority levels of the targets by classifying the targets based on a threat classification criteria, and wherein the attempting to identify the targets includes attempting to identify the targets, based on the preset learning information, in an order based on the threat priority levels of the targets.

According to an embodiment of the present disclosure, the threat classification criteria includes at least one from among an armed status of the targets, an appearance frequency of the targets, an expected movement path of the targets, a distance of the targets, and a speed of the targets.

According to an embodiment of the present disclosure, the displaying includes indicating, to an operator, a presence of the unidentified target before the searching for the information about the unidentified target.

According to an embodiment of the present disclosure, the performing the learning includes: determining whether a result of the learning has achieved a predetermined threshold value, and updating the identification information based on the result of the learning, based on determining that the result of the learning achieved the predetermined threshold value.

According to an embodiment of the present disclosure, the searching includes: using one from among a first search engine of at least one internal database, a second search engine of at least one external network, and a third search engine of at least one operator-designated search engine; or interlinking at least two from among the first search engine, the second search engine, and the third search engine based on an input of a user.

According to an embodiment of the present disclosure, the searching includes: performing a first search for at least one piece of the information corresponding to the unidentified target by searching using a first search engine; and performing, based on the first search not being sufficient to identify the unidentified target, a second search for the at least one piece of the information corresponding to the unidentified target using a second search engine.

According to embodiments of the present disclosure, a system may be provided and include: a fixed weapon system including at least one weapon device fixed at a predetermined position, the fixed weapon system configured to detect and identify targets; at least one processor; and a memory including computer instructions that are configured to, when executed by the at least one processor, cause the at least one processor to: identify the targets detected by the fixed weapon system based on preset learning information; classify the targets according to preset data; search for information about an unidentified target among the targets, that is not identified, based on the preset learning information; determine whether the information about the unidentified target is within a learnable range for performing learning for identifying the unidentified target; and perform the learning based on the information.

According to an embodiment of the present disclosure, the computer instructions may be further configured to, when executed by the at least one processor, cause the at least one processor to: update identification information about the unidentified target based on learned information about the unidentified target obtained from the learning; and transmit the identification information, that is updated, to the fixed weapon system.

According to the aforementioned and other embodiments of the present disclosure, at least the following effects are achieved.

Based on the information collected through each detection/tracking device of a fixed anti-aircraft weapon system, it is possible to identify collected targets and manage information on the identified targets, display the information to operators, notify and display unidentified targets separately from the identified targets, display information on the unidentified targets to designated operators, store and learn the information on the unidentified targets, update the information on the unidentified targets to convert it into identifiable information, and link the information on the unidentified targets to both the operators and the fixed anti-aircraft weapon system, providing the advantage of generalizing information on both the identified targets and the unidentified targets.

Additionally, by generalizing the information on both the identified targets and the unidentified targets, it is possible to maximize mission efficiency, scalability, and capabilities.

However, aspects and effects of embodiments of the present disclosure are not restricted to those set forth above. The above and other aspects and effects of embodiments of the present disclosure will become more apparent to one of ordinary skill in the art to which the present disclosure pertains by referencing the detailed description of the present disclosure given below.

### BRIEF DESCRIPTION OF DRAWINGS

The above and other aspects and features of the present disclosure will become more apparent by describing in detail non-limiting example embodiments of the present disclosure with reference to the attached drawings, in which:

FIG. 1 is a schematic diagram illustrating a system according to an embodiment of the present disclosure.

FIG. 2 is a schematic block diagram illustrating a configuration of the system according to an embodiment of the present disclosure.

FIG. 3 is a detailed block diagram illustrating a configuration of the system according to an embodiment of the present disclosure.

FIG. 4 is a block diagram illustrating an operational feature of the system according to an embodiment of the present disclosure.

FIG. 5 is a schematic flowchart illustrating a method for generalizing identified and unidentified target data in a fixed anti-aircraft weapon system according to an embodiment of the present disclosure.

### DETAILED DESCRIPTION

Advantages and features of embodiments (including methods) of the present disclosure will become apparent from the descriptions of non-limiting example embodiments provided below with reference to the accompanying drawings. However, the present disclosure is not limited to the example embodiments described herein, and may be implemented in various ways. The example embodiments are provided for making the present disclosure thorough and for fully conveying the scope of the present disclosure to those skilled in the art. Like reference numerals denote like elements throughout the descriptions.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

Terms used herein are for describing example embodiments rather than limiting the present disclosure. As used herein, the singular forms are intended to include plural forms as well, unless the context clearly indicates otherwise. Throughout this specification, the word “comprise” (or “include”) and variations such as “comprises” (or “includes”) or “comprising” (or “including”) will be understood to imply the inclusion of stated elements but not the exclusion of any other elements.

Hereinafter, non-limiting example embodiments of the present disclosure will be described in detail with reference to the accompanying drawings.

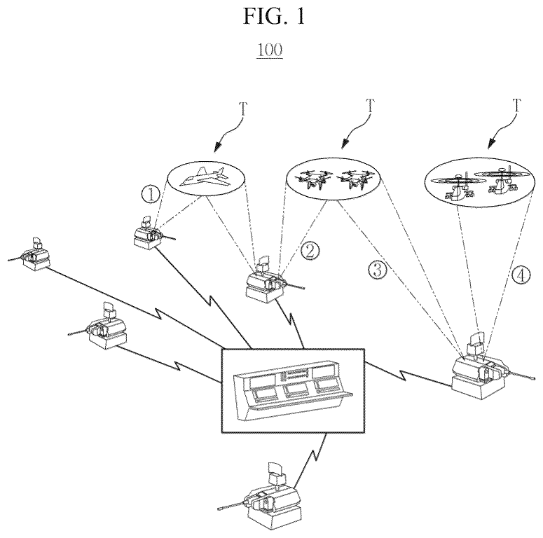

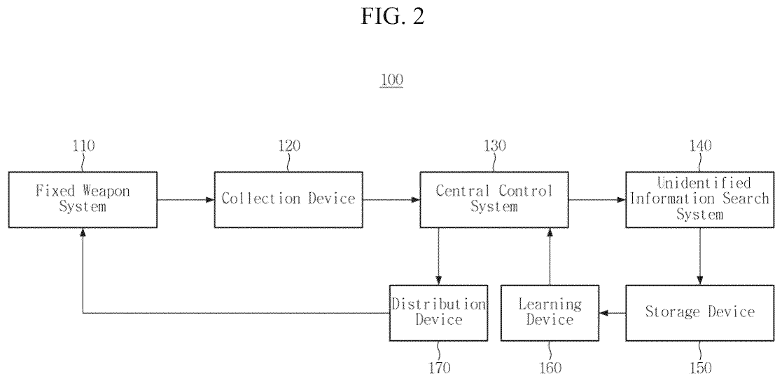

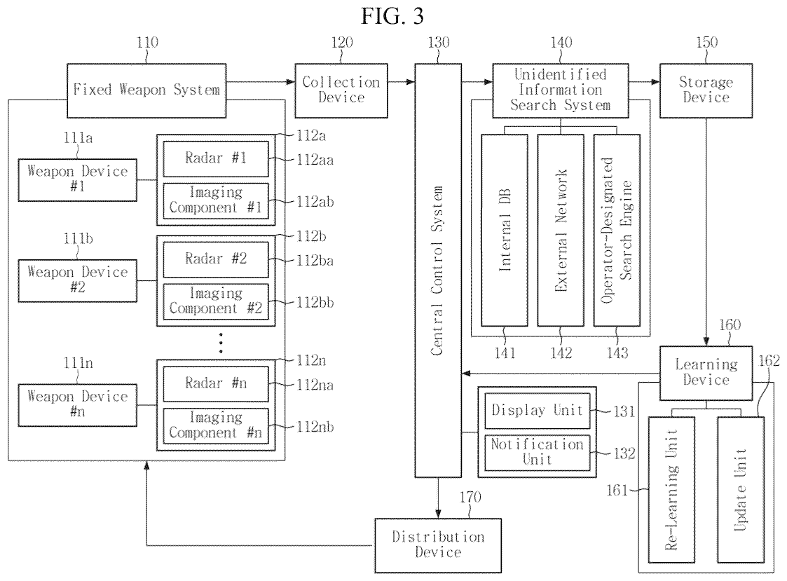

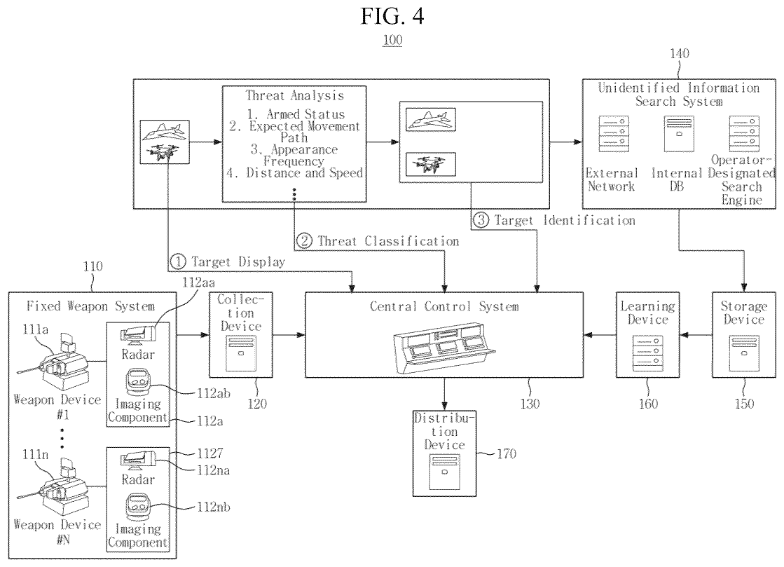

FIG. 1 is a schematic view illustrating a system 100 for generalizing identified and unidentified target data in a fixed anti-aircraft weapon system according to an embodiment of the present disclosure. FIG. 2 is a schematic block diagram illustrating a configuration of the system 100. FIG. 3 is a detailed block diagram illustrating a configuration of the system 100. FIG. 4 is a block diagram illustrating an operational feature of the system 100.

Referring to FIGS. 1-4, the system 100 may include a fixed weapon system 110, a collection device 120, a central control system 130, an unidentified information search system 140, a storage device 150 (e.g., a storage), a learning device 160, and a distribution device 170 (e.g., a network interface).

The fixed weapon system 110 may include one or more weapon devices 111a through 111n that are fixed at their designated locations. The weapon devices 111a through 111n may be configured to be interlinked (e.g., wired or wirelessly) with the central control system 130, which will be described below, and to detect and identify targets T.

The weapon devices 111a through 111n may be provided with (heterogenous/multiple) detection/tracking sensors 112a through 112n, respectively. For example, the detection/tracking sensors 112a through 112na (e.g., radars 112aa through 112na or imaging components 112ab through 112nb) may be mounted on the weapon devices 111a through 111n, respectively. Accordingly, the weapon devices 111a through 111n may detect the targets T, such as enemy low-altitude unmanned aerial vehicles (UAVs), enemy drones, or enemy attack helicopters, through the radars 112aa through 112na or imaging components 112ba through 112nb while being fixed at their designated locations.

The central control system 130 may be interlinked with the fixed weapon system 110 and may be configured to identify, display, and classify information, and operate/control the weapon devices 111a through 111n to receive information on the targets T (e.g., enemy low-altitude UAVs, enemy drones, or enemy attack helicopters) detected by the weapon devices 111a through 111n and handle the targets T.

The central control system 130 may include a display unit 131 (e.g., a display), which displays all the targets T collected from the fixed weapon system 110.

The targets T collected from the weapon devices 111a through 111n may be displayed on the display unit 131 of the central control system 130. Additionally, information on targets T identified according to pre-learned information of the central control system 130 may also be displayed by the display unit 131. Moreover, the display unit 131 may display unidentified targets that cannot be identified according to the pre-learned information of the central control system 130, as well as the targets T and their identification information. At this time, the unidentified targets may be displayed distinctly on the display unit 131 such as, for example, in a different color or size from identified targets. The operator may check all the targets T that are collected, as well as information on targets identified according to the pre-learned information and the unidentified targets, through the display unit 131.

The central control system 130 may identify the targets T detected by the weapon devices 111a through 111n of the fixed weapon system 110 through preset learning information, and classify and display the identified targets according to designated data. For example, the central control system 130 may display (e.g., via the display unit 131) the targets T that are detected to the operator (“Target Display” in FIG. 4) and classify the targets T according to threat classification criteria. Moreover, the central control system 130 may be configured to identify targets T classified as threats according to their threat priority levels from the pre-learned information.

Here, the threat classification criteria may include at least one factor from among an armed status, an appearance frequency, an expected movement path, distance, and a speed of the targets T that are collected, and may be configured to vary depending on the weights of these factors and user settings.

Additionally, the central control system 130 may be provided with a notification unit 132 (e.g., an outputter), which alerts the operator to the detection of unidentified targets. Accordingly, the central control system 130 may identify the targets T according to the preset learning information. If there are unidentified targets that cannot be identified according to the preset learning information, the notification unit 132 may be driven (e.g., by the central control system 130) to inform the operator. The notification unit 132 may include at least one outputter that is configured to output at least one from among sound (e.g., a speaker), vibration (e.g., a haptic device), and light emission (e.g., a light), but embodiments of the present disclosure are not limited thereto. The notification unit 132 may include a display device such as a liquid crystal display (LCD), an organic light-emitting diode (OLED), etc., a speaker, a vibrator, not being limited thereto. That is, various modifications may be possible as long as the notification unit 132 enables the operator to recognize the occurrence of unidentified targets.

The unidentified information search system 140 may be configured to search for unidentified targets among the targets T that are not included in the preset learning information.

The unidentified information search system 140 may include at least one from among a first search engine of at least one internal database (DB) 141, a second search engine of at least one external network 142, and a third search engine of at least one operator-designated search engine 143.

The unidentified information search system 140 may implement a search for at least one piece of information corresponding to unidentified targets through at least one from among the first, second, and third search engines. Additionally, the unidentified information search system 140 may search for the at least one piece of information by interlinking the first, second, and third search engines according to an operator-set environment (e.g., settings set based on a user input).

Specifically, because the unidentified targets may be unidentifiable due to the lack of data in the preset learning information of the central control system 130, a search for information on the unidentified targets may be implemented via the unidentified information search system 140 to identify the unidentified targets when they occur.

At this time, a primary search for information on unidentified targets may be conducted through at least one from among the first, second, and third search engines, depending on the operator-set environment of the unidentified information search system 140. If the unidentified targets are unidentifiable by the primary search or there is a lack of retrieved search information, additional searches may be conducted through search engines that are sequentially set to additionally identify the information on the unidentified targets. For example, after the first search engine is set (e.g., by the central control system 130, the unidentified information search system 140, and/or a user) as a primary search engine, the search order may be set (e.g., by the central control system 130, the unidentified information search system 140, and/or a user) in the sequence of the first search engine, the second search engine, and then the third search engine, but embodiments of the present disclosure are not limited thereto. According to this setting, once the unidentified targets are detected, the primary search may be conducted through the primary main search engine (e.g., the first search engine) to collect and search for information. If the information on the unidentified targets retrieved by the primary search engine is insufficient for identification (e.g., if the amount of information retrieved by one from among the first, second, and third search engines (or a fourth, fifth, . . . , n-th search engine) does not reach a set amount of information for identification), the additional searches may be conducted by the unidentified information search system 140 through search engines other than the primary search engine. For example, the first search engine may be set (e.g., by the central control system 130, the unidentified information search system 140, and/or the user) as the primary search engine, the second search engine may be set (e.g., by the central control system 130, the unidentified information search system 140, and/or the user) as the secondary search engine in case that there is no or only insufficient information on the unidentified targets obtained from the primary search, and the third search engine may be set (e.g., by the central control system 130, the unidentified information search system 140, and/or the user) as the tertiary search engine in case there is still no or insufficient information on the unidentified targets obtained from the secondary search. Here, the set amount of information for identification may be the amount of information required for the learning device 160 to learn the unidentified targets, and may be changed (e.g., by the central control system 130 and/or the unidentified information search system 140) according to the operator's settings. For example, if more than 60% of the required amount of information is retrieved, it may be transmitted (e.g., by the central control system 130 and/or the unidentified information search system 140) to the storage device 150 and the learning device 160, which will be described below.

Furthermore, during the primary search or an N-th search for the unidentified targets, the unidentified information search system 140 may be configured to interlink multiple search engines to sum up the search results. For example, during the primary search, the first search engine may be set (e.g., by the central control system 130, the unidentified information search system 140, and/or the user) to search for the unidentified targets, and during the secondary search, the second search engine and the third search engine may be both set (e.g., by the central control system 130, the unidentified information search system 140, and/or the user) to search for the unidentified targets. Alternatively, during the initial search, the first and second search engines may both be set (e.g., by the central control system 130, the unidentified information search system 140, and/or the user) to search for the unidentified targets, and during the secondary search, the third search engine may be set (e.g., by the central control system 130, the unidentified information search system 140, and/or the user) to search for the unidentified targets.

The storage device 150 may receive and store the information retrieved by the unidentified information search system 140 and the storage device 150 and/or the learning device 160 may be configured to determine whether the stored information on the unidentified targets falls within a learnable set range.

The storage device 150 may store the information on the unidentified targets, including images of the unidentified targets retrieved by the unidentified information search system 140 and various specifications corresponding to the unidentified targets. Additionally, when storing the information on the unidentified targets in the storage device 150, augmented target data (e.g., augmented images) and synthesized target data (e.g., synthesized images) may also be stored. For example, the storage device 150 may store images or various specifications of the targets T retrieved by the unidentified information search system 140, and may also store augmented images of the retrieved targets T and synthesized images of the retrieved targets T.

The learning device 160 may receive the information on the unidentified targets stored in the storage device 150 and perform learning.

The learning device 160 may be configured to receive the information stored in the storage device 150 and determine whether the results of learning conducted by the learning device 160 meet the operator's specified performance. Then, if the results of the learning performed by the learning device 160 exceed a predetermined threshold value, the learning device 160 may update the learned information and transmit the learning results to the central control system 130. In other words, the information retrieved by the unidentified information search system 140 may be stored in real-time in the storage device 150, and the information stored in the storage device 150 may be transmitted to the learning device 160 for learning to identify the unidentified targets. The learning device 160 may receive search information on the unidentified targets from the storage device 150, and determine whether the amount of received information is sufficient for learning. The learning device 160 may determine whether the amount of received information on the unidentified targets has reached the learnable set range. Then, if the amount of received information on the unidentified targets is determined to be within the learnable set range, learning for the identification of the unidentified targets may be performed (e.g., by the learning device 160).

According to embodiments of the present disclosure, an update unit 162 of the learning device 160 may perform the updating of the learned information.

If the amount of received information on the unidentified targets has not reached the learnable set range, the unidentified information search system 140 may continue to search for information on the unidentified targets, and the retrieved information may be stored in real-time in the storage device 150. The information stored in the storage device 150 may then be transmitted to the learning device 160, which may repeatedly perform, in real-time, an algorithm for determining whether the set performance or the operator-specified performance (e.g., acquisition of an identifiable amount of information) has been achieved.

The learning device 160 may perform learning (or re-learning) using the information received from the storage device 150. For example, a re-learning unit 161 of the learning device 160 may perform the learning (or re-learning). When the performance necessary for identifying the unidentified targets is achieved, the learning device 160 may perform learning to identify the unidentified targets, transmits the information on the identified unidentified targets to the central control system 130, and the central control system 130 may update the identification information of the unidentified targets.

As described above, the information learned and updated by the learning device 160 may be transmitted to the central control system 130. This information may be distributed through the distribution device 170 to the fixed weapon system 110, a designated ally, or a higher system of the fixed weapon system 110 or the designated ally. A “higher system” may refer to another system that is configured to command (e.g., control) the fixed weapon system 110 or the designated ally. According to an embodiment, the distribution device 170 may include a network interface, which may include any one or any combination of a digital modem, a radio frequency (RF) modem, an antenna circuit, a WiFi chip, and related software and/or firmware.

Additionally, the storage device 150 may transmit not only the stored images and specifications of the unidentified targets, but also augmented target data and synthesized target data to the learning device 160. The learning device 160 may implement learning using the augmented target data and synthesized target data, as well as the images and specifications of the unidentified targets, received from the storage device 150.

In this manner, among targets T classified as threats, those with high priority levels may be identified using the pre-learned information and notified to the operator. A search for the unidentified targets among the targets T classified as threats, may be implemented through the unidentified information search system 140. Additionally, continuous searches may be implemented through at least one search engine until the amount of information retrieved achieves the performance necessary for learning the unidentified targets. If the learning results from the learning device 160 achieve the performance necessary for identifying the unidentified targets, the unidentified targets may be identified, and their information may be updated (e.g., by the central control system 130 and/or the distribution device 170) to each of the fixed weapon devices 111a through 111n. Therefore, if targets are detected later by at least one of the fixed weapon devices 111a through 111n, the targets are already updated as identified targets, allowing for quick and easy threat classification.

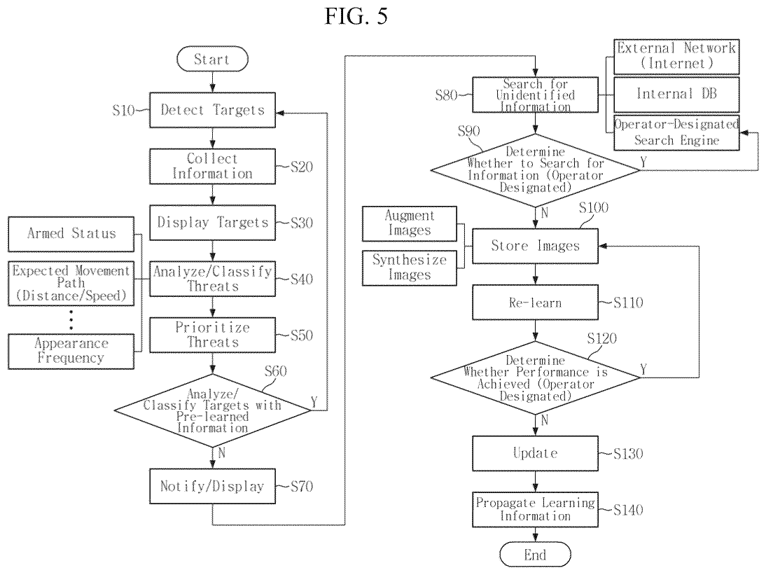

FIG. 5 is a schematic flowchart illustrating a method for generalizing identified and unidentified target data in a fixed anti-aircraft weapon system according to an embodiment of the present disclosure.

Referring to FIG. 5, the method may include the steps of: detecting targets T (operation S10); collecting, displaying, and classifying the targets T (operations S20, S30, S40, and S50); identifying the targets T and determining the presence of unidentified targets through preset learning information (operation S60); performing notification and display (operation S70); searching for the unidentified targets (operations S80 and S90); storing information (e.g., images) of the unidentified targets (operation S100); performing learning (operation S110); determining performance achievement (operation S120); and performing update and distribution (operations S130 and S140).

First, the fixed weapon system 110 (e.g., the fixed weapon devices 111a through 111n) may detect the presence of targets T within a set range while being in a fixed position (operation S10). For example, the fixed weapon devices 111a through 111n may be equipped with the (heterogenous/multiple) detection/tracking sensors 112a through 112n such as the radars 112aa through 112na and/or the imaging components 112ba through 112nb. The radars 112aa through 112na and/or imaging components 112ba through 112nb may detect all the targets T, including enemy low-altitude UAVs, enemy drones, and enemy attack helicopters, within the set range.

Information on the targets T detected by the fixed weapon devices 111a through 111n of the fixed weapon system 110 may be collected by the collection device 120 (operation S20). The information on the targets T collected by the collection device 120 may be transmitted to the central control system 130, and the central control system 130 may display the targets T on the display unit 131 (operation S30) and perform threat analysis and classification on the targets T (operation S40). In other words, the targets T detected by the fixed weapon system 110 may be collected, displayed, and analyzed/classified for threats. All the targets T displayed on the display unit 131 of the central control system 130 may be analyzed and classified according to threat classification criteria.

The step of collecting, displaying, and classifying the targets T (operations S20, S30, S40, and S50) may include the steps of collecting information on the targets T (operation S20), displaying the targets T (operation S30), performing threat analysis and classification on the targets T (operation S40), and prioritizing the targets T (operation S50).

Specifically, information on the targets T detected by the fixed weapon devices 111a through 111n may be transmitted to the collection device 120, and the collection device 120 may collect the information on the targets T (operation S20). The collected information on the targets T may be transmitted to the central control system 130, and the central control system 130 may display all the targets T on the display unit 131 for the operator to check (operation S30). Additionally, the central control system 130 may analyze and classify the targets T, which are displayed, according to the threat classification criteria (operation S40). The targets T (e.g., the information on the targets T) transmitted to the central control system 130 may be analyzed and classified in order of their threat priority levels (operation S50). During operation S40, the targets T may be classified according to the threat classification criteria, which may include an armed status, an appearance frequency, an expected movement path, distance, and speed, and/or weights of the criteria and user settings. The threat classification criteria may be supplemented, modified, and reordered according to the operational environment or mission. The targets T (e.g., the information thereof) delivered to the central control system 130 may be analyzed and classified in order of their threat levels, starting with a target T with the highest threat level, according to the threat classification criteria, and may be identified through the preset learning information of the central control system 130 (“Target Identification” in FIG. 4). When identifying the targets T through the preset learning information of the central control system 130, there may exist unidentified targets among the targets T that are not identified by the preset learning information.

The presence of unidentified targets that cannot be identified by the preset learning information among the targets T classified according to their threat priority levels may be determined (operation S60). If the presence of the unidentified targets is confirmed, the unidentified targets may be transmitted to the unidentified information search system 140 to perform searches for identification, and the unidentified information search system 140 may conduct searches for the unidentified targets for identification (operation S80).

Additionally, after determining the presence of the unidentified targets, if the unidentified targets that cannot be identified by the preset learning information are found among the targets classified according to their threat priority levels before searching for the unidentified targets, the display unit 131 of the central control system 130 may display the occurrence of the unidentified targets to the operator and may provide, via the notification unit 132, sound, vibration, or light to the operator as an alert indicating the occurrence of the unidentified targets (operation S70).

In operation S80, a primary search for the unidentified targets (e.g., a search for the unidentified targets through a main search engine) may be conducted through one of the first, second, and third search engines, according to the operator-set environment of the unidentified information search system 140.

If the identification of the unidentified targets is not possible through the primary search or the retrieved search information from the primary search is insufficient, additional searches may be conducted sequentially through other search engines to identify information on the unidentified targets (operation S90).

For example, in operation S90, after setting the first search engine as the main search engine, the search order may be set in the sequence of the second search engine and the third search engine. According to this setting, once the unidentified targets are detected, the primary search may be conducted through the primary search engine (e.g., the first search engine) to collect and search for information. If the information on the unidentified targets retrieved by the primary search engine is insufficient for identification (e.g., if the amount of information retrieved by one from among the first, second, and third search engines (or a fourth, fifth, . . . n-th search engine) does not reach a set amount of information for identification) the additional searches may be conducted through search engines other than the primary search engine. For example, the first search engine may be set as the primary search engine, the second search engine may be set as the secondary search engine, and the third search engine may be set as the tertiary search engine. Here, the set amount of information for identification may be the amount of information required for the learning device 160 to learn the unidentified targets, and may be changed according to the operator's settings. For example, if more than 60% of the required amount of information is retrieved, it may be transmitted to the storage device 150 and the learning device 160, which will be described later.

Furthermore, during the primary search or an n-th search for the unidentified targets, the unidentified information search system 140 may be configured to interlink multiple search engines to sum up the search results. For example, during the primary search, the first search engine may be set to search for the unidentified targets, and during the secondary search, the second search engine and the third search engine may be both set to search for the unidentified targets. Alternatively, during the initial search, the first and second search engines may both be set to search for the unidentified targets, and during the secondary search, the third search engine may be set to search for the unidentified targets.

The unidentified information search system 140 may search for the unidentified targets, and information on the unidentified targets retrieved by the unidentified information search system 140 may be stored in real-time in the storage device 150 (operation S100). As mentioned above, the information on the unidentified targets retrieved by the unidentified information search system 140 may be stored in the storage device 150, including not only simple image data but also augmented target data and synthesized target data. The information on the unidentified targets stored in the storage device 150 may be transmitted to the learning device 160 and may be used as a learning input for the identification of the unidentified targets.

The learning device 160 may receive the information on the unidentified targets stored in the storage device 150 and perform learning/re-learning for the identification of the unidentified targets (operation S110).

The learning device 160 may implement learning using not only the general target data but also the augmented target data and synthesized target data from the storage device 150. Additionally, the learning device 160 may acquire information from the storage device 150 to implement learning for the identification of the unidentified targets, and verify the performance of the identification of the learned unidentified targets.

Specifically, in operation S120, after performing learning, the learning device 160 may determine whether the results of the learning have achieved a predetermined performance threshold.

In other words, the learning device 160 may receive the information on the unidentified targets from the storage device 150 and perform learning for the identification of the unidentified targets. After performing learning (or re-learning) using the received information, the learning device 160 may verify whether the results of the learning (or re-learning) have achieved the performance required for identifying the unidentified targets. If the performance of the learning results (or re-learning results) does not meet the predetermined performance threshold, the unidentified information search system 140 may continue to conduct searches for the unidentified targets and store the retrieved information from the searches in the storage device 150. The learning device 160 may then perform learning (or re-learning) again using the newly transmitted information from the storage device 150 and determine whether the results of the learning (re-learning) have achieved the performance threshold.

If the performance of the identification of the unidentified targets is determined by the learning device 160 to have achieved the performance threshold, the learned performance value may be transmitted to the central control system 130 and updated as identification data for the unidentified targets (operation S130).

The central control system 130 may distribute the updated identification data for the unidentified targets to the weapon devices 111a through 111n, designated allies, and/or the higher systems of the weapon devices 111a through 111n or the designated allies (operation S140).

As described above, generalization can be achieved not only for identified targets but also unidentified targets.

Each component described above with reference to FIGS. 4, 8 and 10 may be implemented as a software component, such as a task performed in a predetermined region of a memory, a class, a subroutine, a process, an object, an execution thread or a program, or a hardware component, such as a Field Programmable Gate Array (FPGA) or Application Specific Integrated Circuit (ASIC). In addition, the components may be composed of a combination of the software and hardware components. The components may be reside on a computer readable storage medium or may be distributed over a plurality of computers.

Each block may represent a module, segment, or portion of code, which comprises one or more executable instructions for implementing specified logical function(s). It should also be noted that in some alternative implementations, the functions noted in the blocks may occur in an order different from the order(s) described above and shown in the drawings. For example, two blocks shown in succession may in fact be executed substantially concurrently or the blocks may sometimes be executed in the reverse order, depending upon the functionality involved.

According to embodiments of the present disclosure, one or more (e.g., some or all) of the fixed weapon system 110, the collection device 120, the central control system 130, the unidentified information search system 140, the storage device 150, the learning device 160 (including the re-learning unit 161 and/or the update unit 162), and the distribution device 170, may include at least one processor, such as a central processing unit (CPU), a graphic processing unit (GPU), and/or another type of microprocessor, and an internal memory to perform functions of the fixed weapon system 110, the collection device 120, the central control system 130, the unidentified information search system 140, the storage device 150, the learning device 160 (including the re-learning unit 161 and/or the update unit 162), and/or the distribution device 170 described herein (e.g., the above-described functions) and/or other functions by loading corresponding computer code or instructions on the internal memory and executing the computer code or instructions.

According to embodiments of the present disclosure, one or more (e.g., some or all) of the fixed weapon system 110, the collection device 120, the central control system 130, the unidentified information search system 140, the storage device 150, the learning device 160 (including the re-learning unit 161 and/or the update unit 162), and the distribution device 170 may be integrated together in a single device (e.g., a single computing device), and the single device may include at least one processor, such as a central processing unit (CPU), a graphic processing unit (GPU), and/or another type of microprocessor, and an internal memory to perform functions of the single device.

According to embodiments of the present disclosure, one or more (e.g., some or all) of the fixed weapon system 110, the collection device 120, the central control system 130, the unidentified information search system 140, the storage device 150, the learning device 160 (including the re-learning unit 161 and/or the update unit 162), and the distribution device 170 may be separately provided from each other, and may be directly or indirectly connected together by a wired and/or wireless communication device(s).

Non-limiting example embodiments of the present disclosure have been described above with reference to the accompanying drawings. However, modifications and variations to the example embodiments are included within the spirit and scope of the present disclosure. Accordingly, the example embodiments of the present disclosure should be considered as illustrative and not restrictive in all respects.

What is claimed is:

1. A system comprising:
a fixed weapon system comprising at least one weapon device fixed at a predetermined position, the fixed weapon system configured to detect and identify targets;
a central control system configured to control the fixed weapon system, identify the targets detected by the fixed weapon system based on preset learning information, classify the targets according to preset data;
an unidentified information search system configured to search for information about an unidentified target among the targets, that is not identified, based on the preset learning information;
a storage configured to receive and store the information about the unidentified target from the unidentified information search system; and
a learning device configured to receive the information about the unidentified target that is stored in the storage, determine whether the information about the unidentified target is within a learnable range for performing learning for identifying the unidentified target, and perform the learning based on the information.

2. The system of claim 1, wherein the central control system is further configured to display the targets that are detected to an operator, classify the targets according to a threat classification criteria, and identify the targets that are classified as threats, starting from a target with a highest threat priority, using the preset learning information.

3. The system of claim 2, wherein the threat classification criteria comprises at least one from among an armed status of the targets, an appearance frequency of the targets, an expected movement path of the targets, a distance of the targets, and a speed of the targets.

4. The system of claim 2, wherein the central control system further comprises a display, and the central control system is configured to cause the display to display all targets detected by the fixed weapon system.

5. The system of claim 4, wherein the central control system is further configured to cause the display to display the unidentified target that cannot be identified by the central control system according to the preset learning information, and
wherein the system further comprises an outputter, and the central control system is further configured to cause the outputter to alert the operator to detection of the unidentified target.

6. The system of claim 1, wherein the learning device is further configured to:
determine whether a result of the learning performed by the learning device, based on the information about the unidentified target, has exceeded a predetermined threshold value; and
update learned information and transmit result of the learning to the central control system based on the result exceeding the predetermined threshold value.

7. The system of claim 6, wherein the central control system is further configured to update identification information about the unidentified target based on the result of the learning.

8. The system of claim 7, wherein the central control system is further configured to distribute the identification information that is updated to the fixed weapon system, a designated ally, or another system configured to command the fixed weapon system or the designated ally.

9. The system of claim 1, wherein the unidentified information search system is further configured to search for at least one piece of the information corresponding to the unidentified target by:
using one from among a first search engine of at least one internal database, a second search engine of at least one external network, and a third search engine of at least one operator-designated search engine; or
interlinking at least two from among the first search engine, the second search engine, and the third search engine based on an input of a user.

10. The system of claim 9, wherein the unidentified information search system is further configured to:
perform a first search for the at least one piece of the information corresponding to the unidentified targets by searching using the one from among the first search engine, the second search engine, and the third search engine; and
based on the first search not being sufficient to identify the unidentified target, perform a second search for the at least one piece of the information corresponding to the unidentified target using another from among the first search engine, the second search engine, and the third search engine.

11. The system of claim 1, wherein the storage is further configured to store augmented target data or synthesized target data when storing the information about the unidentified target, and
wherein the learning device is further configured to perform the learning using the information about the unidentified target and at least one from among the augmented target data and the synthesized target data.

12. A method performed by at least one processor, the method comprising:
detecting targets by at least one fixed weapon device of a fixed weapon system;
receiving information about the targets from the fixed weapon system;
attempting to identify the targets based on preset learning information;
displaying the targets on a display;
classifying the targets according to preset data;
determining that there is an unidentified target among the targets that are attempted to be identified;
searching, based on determining that there is the unidentified target among the targets, for information about the unidentified target;
determining whether the information about the unidentified target is within a learnable range for performing learning for identifying the unidentified target;
obtaining learned information about the unidentified target by performing, based on determining that the information about the unidentified target is within the learnable range, the learning based on the information about the unidentified target;
updating identification information about the unidentified target based on the learned information about the unidentified target; and
transmitting the identification information, that is updated, to the fixed weapon system.

13. The method of claim 12, wherein the classifying the targets comprises obtaining threat priority levels of the targets by classifying the targets based on a threat classification criteria, and
wherein the attempting to identify the targets comprises attempting to identify the targets, based on the preset learning information, in an order based on the threat priority levels of the targets.

14. The method of claim 13, wherein the threat classification criteria comprises at least one from among an armed status of the targets, an appearance frequency of the targets, an expected movement path of the targets, a distance of the targets, and a speed of the targets.

15. The method of claim 13, wherein the displaying comprises indicating, to an operator, a presence of the unidentified target before the searching for the information about the unidentified target.

16. The method of claim 12, wherein the performing the learning comprises:
determining whether a result of the learning has achieved a predetermined threshold value, and
updating the identification information based on the result of the learning, based on determining that the result of the learning achieved the predetermined threshold value.

17. The method of claim 12, wherein the searching comprises:
using one from among a first search engine of at least one internal database, a second search engine of at least one external network, and a third search engine of at least one operator-designated search engine; or
interlinking at least two from among the first search engine, the second search engine, and the third search engine based on an input of a user.

18. The method of claim 12, wherein the searching comprises:
performing a first search for at least one piece of the information corresponding to the unidentified target by searching using a first search engine; and
performing, based on the first search not being sufficient to identify the unidentified target, a second search for the at least one piece of the information corresponding to the unidentified target using a second search engine.

19. A system comprising:
a fixed weapon system comprising at least one weapon device fixed at a predetermined position, the fixed weapon system configured to detect and identify targets;
at least one processor; and
a memory comprising computer instructions that are configured to, when executed by the at least one processor, cause the at least one processor to:
identify the targets detected by the fixed weapon system based on preset learning information;
classify the targets according to preset data;
search for information about an unidentified target among the targets, that is not identified, based on the preset learning information;
determine whether the information about the unidentified target is within a learnable range for performing learning for identifying the unidentified target; and
perform the learning based on the information.

20. The system of claim 19, wherein the computer instructions are further configured to, when executed by the at least one processor, cause the at least one processor to:
update identification information about the unidentified target based on learned information about the unidentified target obtained from the learning; and
transmit the identification information, that is updated, to the fixed weapon system.
